(19) United States
(12) Patent Application Publication
(10) Pub. No.: US 2009/0227283 A1
(43) Pub. Date: Sep. 10, 2009

(54) Electronic device

(76) Inventor: Timo Pekka Pylvanainen, Tampere (FI)

Correspondence Address: HARRINGTON & SMITH, PC, 4 RESEARCH DRIVE, Suite 202, SHELTON, CT, 06484-6212, US

(21) Appl. No.: 11/887,177

(22) PCT Filed: Apr. 13, 2006
(86) PCT No.: PCT/JP2006/308254

§ 371 Date: Sep. 25, 2007

(30) Foreign Application Priority Data
Apr. 15, 2005 (JP) 2005-119084

(51) Int. Cl. H04M 1/00; G06K 9/72

(52) U.S. Cl. 455/556.1; 382/229

(57) ABSTRACT

Electronic device: including an image sensor; a screen for displaying a view captured by the image sensor; a motion detector for detecting a motion of the electronic device; and a variable being associated with a position on the screen and a specific selecting manipulation; and the electronic device being arranged: to change a value of the variable in every moment triggered by the selecting manipulation so as to compensate a motion of the electronic device by utilizing the motion detector; and to define an operation area associated with an operation of the electronic device based on the value of the variable. The above-described electronic device enables a user to interact with information of the real world intuitively.

### FIELD OF TECHNOLOGY

This invention relates to an electronic device comprising a camera. In particular this invention relates to a method and an apparatus for defining operation area in such electronic device, and to an application of the image data taken by the camera.

### BACKGROUND

In recent years, technologies to superimpose computer-generated graphics such as images or characters on a real world have attracted increasing attention. By presenting a real world overlapped with supplemented information, it is possible to strengthen relationships between a real world and a human being. Such technologies are called as Augmented Reality, and have been studied in, e.g., Columbia University in United States.

(See http://www1.cs.columbia.edu/graphics).

Recent portable electronic devices such as mobile phones or PDAs have been equipped with a high-resolution camera, and their processing powers have become so powerful and equal to several yeas-old personal computers. Cameras have an ability to capture a real world, and processing units can create graphics such as images and characters. The processing ability of recent portable electronic devices has been enough powerful to extract character information from image data by OCR (optical character recognition), as written in WO02/41241.

Accordingly, the inventor of the present invention has come to create a new concept for electronic devices that make it possible for a user to interact with real world intuitively, by combining image of real world taken by the camera, and processing power of electronic device.

### SUMMARY OF THE INVENTION

A purpose of this invention is to provide a technology for enabling a user to interact with information of the real world intuitively.

According to one aspect of the present invention, there is provided an electronic device comprising:
an image sensor;
a screen for displaying a view captured by the image sensor;
a motion detection means for detecting a motion of the electronic device; and
a variable being associated with a position on the screen and a predetermined selecting manipulation;
   and the electronic device being arranged:
to change a value of the variable in every moment triggered by the selecting manipulation so as to compensate a motion of the electronic device by utilizing the motion detection means; and
to define an operation area associated with an operation of the electronic device based on the value of the variable.

The number of the variables may be one or more. In one embodiment, the above-described electronic device may comprise a plurality of variables, each of them being associated with a own position on the screen and a own selecting manipulation, and wherein the electronic device may be arranged to define said operation area based on values of said plurality of variables.

At the moment when the selecting manipulation is done, the value of the variable can be corresponds to a specific position on the screen, for example, the center. In such embodiment, a user can designate a specific point of a view of the real world, which is displayed on the screen, by moving the electronic device to make the specific point being displayed at the center of the screen and by performing the selecting manipulation. Once the selecting manipulation is performed, the electronic device starts changing a value of the variable in every moment so as to compensate a motion of the electronic device by the help of the motion detection means. Therefore, even if the user moves the electronic device, the position on the screen plane corresponding to the value of the variable keeps pointing the same point of the view of the real world. (Of course, the accuracy depends on the performance of the motion detection means.) Therefore, the selecting manipulation brings an effect as if marking on the view of the real world. By repeating moving the electronic device and doing the selecting manipulation several times, the user can put marks on different places of the real world. Then an operation area associated with an operation of the electronic device will be defined based on the marks.

In this way, according to the above-described electronic device, the user can decide the area of the real world projected to the screen by moving the electronic device, which is a very intuitive way of operation. The decided area may be used for any operations of the electronic device such as taking a picture, performing an OCR processing to extract character information from the picture, adjusting a focus, or adjusting white balancing. Thus by virtue of the present invention, the user can interact with information of the real world in very intuitive way. It may be able to say that, the above-described electronic device provides a very intuitive user interface to interact with the real world.

To enhance the virtue of the above-described electronic device, preferably the selecting manipulation may be an intuitive one. For this purpose, in one embodiment, above-described electronic device may be arranged in that a first round of said selecting manipulation is a pressing the key, and a second round of said selecting manipulation is a releasing the key. In addition, the electronic device may be arranged to define said operation area when the same key is pressed again. The key (or button) for the above selecting or defining manipulation may be a dedicated one, or a shared one having different functions. In this embodiment, the selecting operation may be more intuitive because the user can select the area of the real world by a simple key manipulation. In addition, the selecting or defining manipulation may utilize an audio input means.

To enhance the virtue of the above-described electronic device, preferably, the electronic device may be arranged to indicate on the screen a position relating to the value of the variable. Preferably the way of indication is the one which can be easily recognized by the user, i.e. a bright point or a mark with any shapes. Further preferably, the electronic device may be arranged to define a screen area based on the value of the variable, and to indicate the screen area on the screen. The way of indication may be, i.e. highlighting by a fluorescent color or emphasizing the border by colored line. Later the screen area may be decided as said operation area. However, before being decided, as the value of the variable is changed in every moment in response to the movement of the electronic device, the screen area is also changed in every moment. Thus in these embodiment, the user can check a selected point and/or a preview of the operation area with the real world in overlapped manner on the screen, which enables the user's operation more intuitive.

Moreover, in these embodiments, as the value of the variable is changed so as to compensate the movement of the electronic device, the place where the bright point or the screen area is designating does not change in the screen even the electronic device is moved. (As mentioned above, the accuracy depends on the performance of the motion detection means.) Therefore the user can really select a scene of the real world by the electronic device according to the present invention. In this way, the present invention provides a very intuitive way for interacting with the real world.

To enhance the virtue of the above-described electronic device, a housing of the electronic device may be a handheld size, the screen may be located on a front surface of the housing, and an entrance for an incident light to the image sensor may be located on a back surface of the housing. A user in this electronic device may be able to actively interact with information of the real world, i.e., image or character information, by utilizing the mobility resulted from the small size and the intuitive and easy user interface provided from the virtue of the present invention. Imaging phones or PDAs equipped with cameras may be suitable objects to apply the present invention.

In the above-described electronic device, the shape of said operation area can be defined in many ways. In one embodiment, the electronic device may be arranged in that the shape of the operation area may be defined as a rectangle, wherein a value of the variable associated with a first round of said selecting manipulation may be related with a upper-left corner of the rectangle, and a value of the variable associated with a second round of said selecting manipulation may be related with a lower-right corner of the rectangle. Further, in the other embodiment, the electronic device may be arranged in that the shape of the operation area may be defined as a circle or oval having a radius associated with a distance between a value of the variable and an initial value of the same variable.

In one embodiment of the above-described electronic device, said motion detection means may comprise at least one of the accelerometer, gyroscopes, and magnetometer. In the other embodiment, the motion detection means comprising an image processing means for detecting a motion of the electronic device, such as comparing consecutive frames. The image processing may be purely software processing, or may be performed with the help of a dedicated hardware, i.e. a DSP. In the further embodiment, the motion detection means may comprise both sensors and image processing means.

The features of the above-described electronic devices may be achieved by software processing. With this in mind, according to another aspect of the present invention, there is provided a computer program for an electronic device comprising an image sensor, a screen for displaying a view captured by the image sensor, and a motion detection means for detecting a motion of the electronic device; the computer program further comprising:
a variable being associated with a position on the screen and a predetermined selecting manipulation;
   and the computer program being arranged to instruct:
to change a value of the variable in every moment triggered by the selecting manipulation so as to compensate a motion of the electronic device by utilizing the motion detection means; and
to define an operation area associated with an operation of the computer program based on the value of the variable.

According to still further aspect of the present invention, there is provided a method for defining an operation area associated with an operation of an electronic device comprising an image sensor, a screen for displaying a view captured by the image sensor, and a motion detection means for detecting a motion of the electronic device, wherein:
preparing a variable being associated with a position on the screen and a predetermined selecting manipulation;
changing a value of the variable in every moment triggered by the selecting manipulation so as to compensate a motion of the electronic device by utilizing the motion detection means; and
defining the operation area based on the value of the variable.

### BRIEF DESCRIPTION OF THE DRAWINGS

The present invention will now be described by way of example with reference to the accompanying drawings, in which:

FIG. 1 illustrates an appearance of the imaging phone 1 according to the present invention.

FIG. 2 illustrates the operation of the imaging phone 1 at preview mode.

FIG. 3 is a schematic block diagram of hardware configuration of the imaging phone 1.

FIG. 4 is a schematic block diagram of software configuration of OCR software 19 according to the present invention.

FIG. 5 is a flow chart to describe how the OCR software 19 works.

FIG. 6 illustrates views of the LCD screen 2 during the OCR software 19 is working.

FIG. 7 illustrates an another embodiment of the area selection module 33 according to the present invention.

### DETAILED DESCRIPTION OF THE PREFERRED EMBODIMENTS

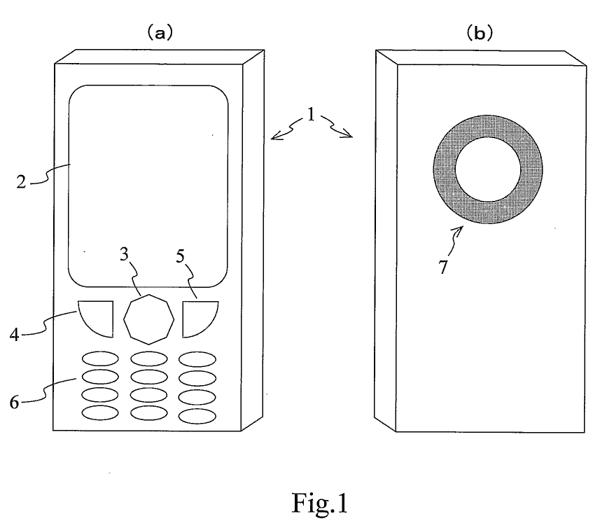

The present invention will now be described by using exemplary embodiments with reference to the accompanying drawings. In particular, the present invention will be described in relation to an imaging phone with an OCR function. FIG. 1 shows appearance of an imaging phone according to the present invention. FIG. 1(a) shows a front view and (b) shows back view. An imaging phones 1 comprises a LCD screen 2, a function key 3, a left key 4, a right key 5, and ten key 6 on the front side, and a camera 7 on the back side. The LCD screen 2 displays information relating to cellular phone functions such as signal condition, remaining battery, phone number. The LCD screen 2 is also used as a display for installed applications. The LCD screen 2 is also used as a monitor of the camera 7. A view of which a user is going to capture will be displayed on the LCD screen 2. The function key 3, the left key 4, and the right key 5 are used to access to various functions of the imaging phone 1. In addition, the left key 4 and the right key 5 are used for on-hook and off-hook. The ten key 6 is used to input phone numbers and texts. Most of the keys are allocated several functions on them. The imaging phone 1 comprises not only telephony and camera functions, but also various functions such as an OCR function for extracting character information from image data taken by the camera 7, a messaging function such as e-mail or MMS, games, and a scheduler.

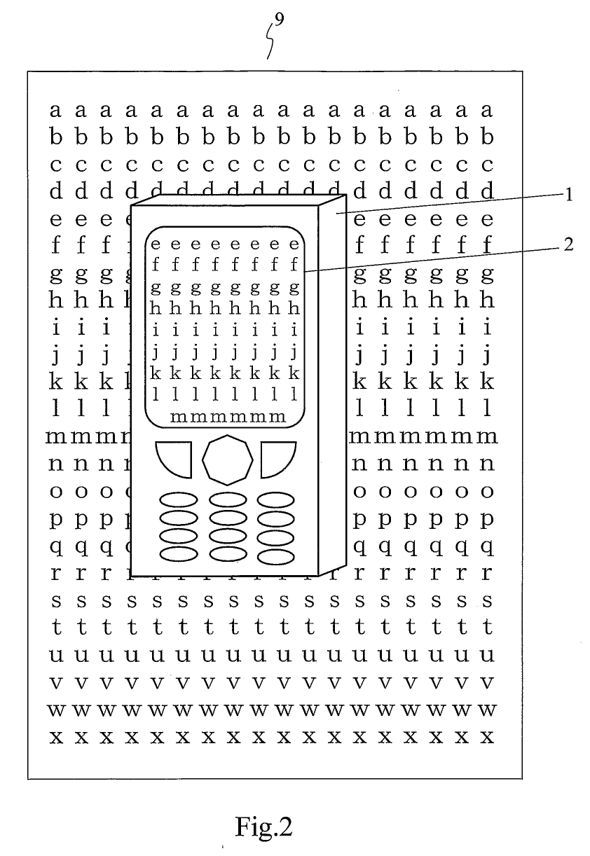

When a user is going to take a picture by using the imaging phone 1, the imaging phone 1 takes a view to be shot by the camera 7, and shows the view on the screen 2 as a preview. Referring to FIG. 2, the number 9 expresses a newspaper, and alphabet a, b, c, & on the newspaper 9 expresses articles, that is, character information. The imaging phone 1 shoots the newspaper by the camera 7, and shows it on the screen 2. At the preview mode, the imaging phone performs shooting about 10 times in a second, and updating the screen 2 in each time. Thus the real world is displayed on the screen 2 thought the camera 7 in real-time. At taking a picture, the function button 3 plays a role as a shutter button. Photograph data are stored in a memory of the imaging phone 1.

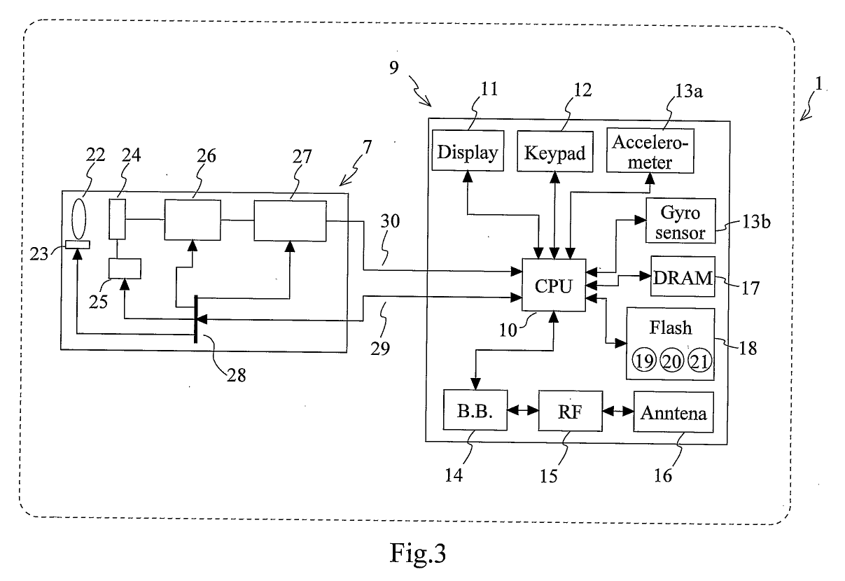

FIG. 3 is a schematic block diagram showing hardware configuration in simple form. Generally, the imaging phone 1 comprises a phone module 9 and the camera module 7. The phone module 9 comprises a CPU 10, and CPU 10 is connected with a display 11, a keypad 12, an accelerometer 13a, a gyrosensor 13b, a baseband processing unit 14, a DRAM 17 and a flash memory 18. The flash memory 18 stores an operating system (OS) 21 of the imaging phone 1. CPU 10 and OS 21 cooperate in each other to compose a controller for controlling operations of the imaging phone 1. The flash memory 18 also stores an OCR software 18 taking charge of the OCR function of the imaging phone 1, a MMS software 20 taking charge of the messaging function, and a variety of application software. These software cooperate with CPU 10 and the other hardware of the imaging phone 1 to operate the imaging phone 1 as an information processing apparatus with specific functions. The display 11 comprises the LCD screen 2. Keypad 12 comprises a plurality of keys such as function key 3, left key 4, right key 5, and ten key 6 shown in FIG. 1. The accelerometer 13a is a 3-dimensional accelerometer which is used to detect an inclination and a linear movement of the imaging phone 1. The gyroscope is also a 3-dimensional gyroscope which is used to detect a rotation of the imaging phone 1. The baseband processing unit 14 is connected to a RF processing unit 15 and an antenna 16. They are taking charge of functions relating to signal transmission and reception. The baseband-processing unit 14 works for digital encoding/decoding, error correction, and so on. The RF processing unit 15 works for frequency conversion to/from a carrier frequency and so on. DRAM 17 works as a main memory of the imaging phone 1. Since DRAM have a faster access speed than flash memory, frequently used data or programs will be stored in the DRAM when the imaging phone 1 is working. OS21 or other application software may also be moved (or copied) to and used from the DRAM 17 when the imaging phone 1 is working; even initially they are stored in the flash memory 18. SRAM or SDRAM may be used as a main memory.

Camera module 7 comprises a lens 22, a lens motor 22, a CCD sensor 24, a CCD driver 25, a pre-processing unit 26, an image construction unit 27, a bus 28, and etc. Lens 22 attracts incident light to CCD sensor 24. FIG. 3 shows only one piece of lens for the lens 22, but actually it often comprises a plurality of lenses. Lens motor 23 is arranged to move a position of a lens, and it is used for focusing or an optical zooming. CCD sensor 24 is a sensor which converts incident light into an electric signal. CCD driver 25 controls timing and a resolution of data acquisition with CCD sensor 24. The pre-processing unit 26 performs analog-to-digital conversion for an output signal of CCD sensor 24, and adjusting white balance. The output signal of the pre-processing unit 26 is still a raw data and is not a format for displaying or printing by general imaging phones or personal computers. The image construction unit 27 builds the output signal of the pre-processing unit 26 as an image data with RGB or YUV format, by interpolation processing. This image data can be displayed or printed by using various imaging phones or personal computers. The image data is sent to the phone module 9 via a data interface 30.

CPU 10 is connected to the lens motor 23, CCD driver 25, pre-processing unit 26, and etc though a data interface 29 and the bus 28. On this account CPU 10 can adjust focusing or zooming by controlling the lens motor 23, change a resolution for data taking by controlling the CCD driver 25, and adjust white balance of the image by controlling pre-processing unit 26. Before taking a picture, a view to be taken will be displayed on the screen of the display 11 for previewing. At the preview mode, CPU 10 controls CCD driver 25 so that the CCD sensor 24 performs capturing in a small resolution but about 10 times in a second. Thus the user can see a view to be taken on the screen 2 in real time at the preview mode. At taking a picture, CPU 10 controls CCD driver 25 so that the CCD sensor 24 captures a data in its maximum resolution.

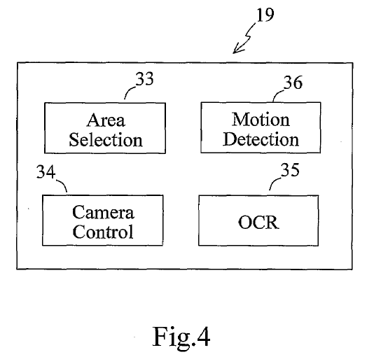

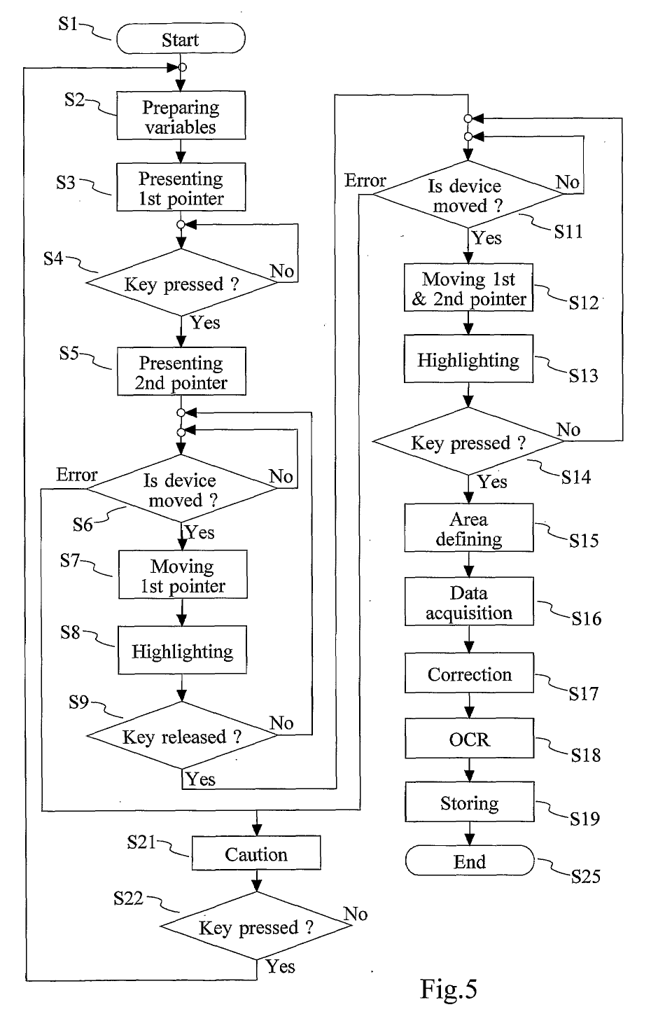

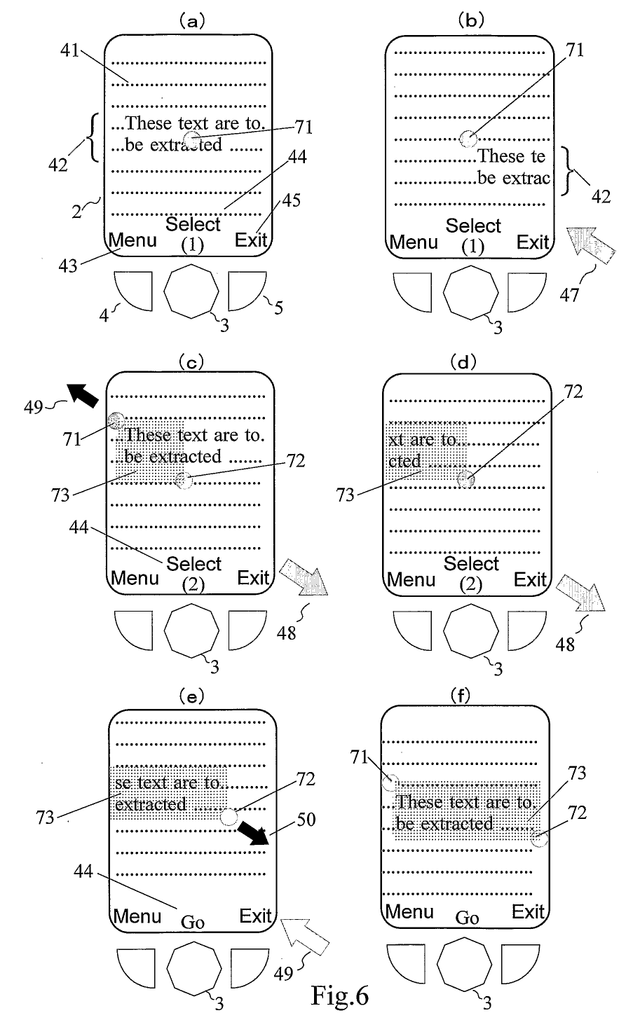

FIG. 4 shows a structure of the OCR software 19. The OCR software 19 comprises four software modules, an area-selection module 33, a camera-control module 34, an OCR module 35, and a motion detection module. The area-selection module 33 provides an user interface for defining an area for OCR in the real world. A user can select the OCR area as if he/she puts the marks on the real world with watching a view of the real world in the screen 2. The detail of the area-selection module 33 will be described later with reference to FIGS. 5 and 6.

The camera control module 34 displays scenes captured by the CCD sensor 24 and takes an image data of a view of the area defined by the area selection module 33. The camera selection module is not necessarily equipped with commands for directly controlling the camera module 7. Such commands may be incorporated in the OS 21 or in another camera control software stored in DRAM 17 or flash memory 18. In this case, the camera control module 34 may comprises a software interface to exchange instructions or data with the camera control software. The software interface may comprise an instruction to the camera control software such as “supply a preview image” or “Performing data acquisition in the designated area”.

The OCR module 35 applies OCR to the image data provided by the camera control module 34 to obtain character information. OCR algorithms have been already known, so any algorithm may be used if it matches with the requirements of i.e. processing speed, power consumption, or language. The OCR module 35 stores character information obtained by OCR in a shared memory space which is used to transfer data between applications or within an application. Thus the character information provided by the OCR software 19 may be utilized from various application installed in the imaging phone 1.

The motion detection module 36 comprises an image-processing program for measuring a motion of the imaging phone 1 by comparing consecutive frames in corporation with CPU 10. The motion detection module 36 also measures the motion of the imaging phone 1 from output signals of the accelerometer 13a and the gyrosensor 13b. The output signal of the accelerometer 13a is used to know an inclination and a linear movement of the imaging phone 1. The gyrosensor 13b is used to know a rotational movement.

Referring to FIGS. 5 and 6, the working of the OCR software 19 will be described-below in detail. FIG. 5 is a flow chart to describe how the OCR software 19 works, and FIG. 6 illustrates views of the LCD screen 2 during the OCR software 19 is working. FIG. 6 (a)˜(f) illustrates only LCD screen 2, function key 3, left key 4, and right key 5 for hardware components of the imaging phone 1.

In step S1, the OCR software 19 starts to run. Then the OCR software 19 instructs the CPU 10 to set the imaging phone 1 to the preview mode. The instruction may be directed to the OS 21 or the other camera-module control software. According to the instructions of OCR software 19 or the other software, CPU 10 controls the camera module 7 to perform data acquisition about 10 times per a second for previewing, and displays obtained image data on the LCD screen 2 one after another. Thus the scene of the real world is displayed on the screen 2 in real-time. This is shown in FIG. 6 (a).

FIG. 6(a) is a screen where the OCR software 19 started. Referring to FIG. 6 (a), a view of the real world 41 taken through the camera module 7 is displayed on the screen 2. And it is written as “Menu” in lower left corner 43 of the screen, which shows that if the left key 4 is pressed a menu to access the function of area selection module 33 will be displayed. Also it is written as “Exit” on lower right corner of the screen corner 45, which shows that if the right key 5 is pressed the OCR software 19 will stop to run. It is written as “Select (1)” in lower center 44 of the screen, which shows that if the function key is pressed, a starting point of the area for OCR will be decided. Watching the view 41, we can find an area 42 at the central area of the screen where character information “These text are to be extracted” exists. In the following, by taking it as an example to obtain this string as character information by OCR, it will be continued to describe the working of the OCR software 19.

In step 2, the area selection module 33 prepares two variables to put marks on specific places of the real world displayed on the screen 2. Hereafter, it is called a first variable and a second variable respectively. Each of the variables has 2-dimensional or 3-dimensional coordinates as an internal parameter, and its initial value corresponds to a central position on the screen 2.

In step 3, the area selection module 33 instructs CPU 10 to present a first pointer 71 at the position on the screen 2 corresponding to the value of the first variable. The first pointer 71 is used to specify the starting point of the area for OCR. As shown in FIG. 6(a), initially the first pointer 71 is fixed to the screen center of the start screen because the value of the first variable corresponds to the center of the screen. Then, the user adjusts the spatial position of imaging phone 1 so that the upper left corner of area 42, where OCR should be performed, is displayed at the center of screen 2, by moving imaging phone 1 to the direction 47 by the hand. See FIG. 6(b). When the adjustment is finished, the user presses the function key 3.

In step S4, the area selection module 33 is in the state to observe the pressing of the function key 3 in cooperation with the CPU 10. By detecting the function key 3 being pressed, the area selection module 33 instructs the CPU10 to display a second pointer 72 at the position on the screen 2 corresponding to the value of the second variable, that is, the center of the screen (step S5) (See FIG. 6(c)). The second pointer 72 is used to specify the ending point of the area for OCR. The user moves the imaging phone 1 by hand to the direction 48 so that the lower right corner of area 42 is projected onto the center of the screen. While the user moving the imaging phone 1, the user keeps pressing the function key 3.

At this time, the area selection module 33 is in a state to observe the movement of the imaging phone 1 by using movement detection module 36 (step S6). When detecting the imaging phone being moved, the area selection module 33 changes the value of the first variable so as to compensate the movement of the imaging phone 1. In addition to this, the area selection module 33 instructs the CPU 10 to re-display the first pointer 71 at the position on the screen 2 corresponding to the new value of the first variable. As a result, the first pointer 71 moves on screen 2 to the direction 49 which is opposite to direction 48. Therefore, even the imaging phone 1 moves the place where the first pointer 71 is pointing does hardly change. In another words, the first pointer 71 tracks on the screen 2 a place of the real world where it pointed at the beginning. The accuracy of the tracking depends on the performance of the motion detection module 36. In this way, as shown in FIG. 6(c), even the view of the real world on the screen 2 has changed, the first pointer 71 is still pointing the upper left corner of area 42. Thus, the pressing the function key 3 by the user in step S4 has resulted an effect as if the he/she puts a mark on a point of the real world.

As the value of the second variable corresponds to the center of the screen 2, the second pointer 72 is also fixed at the center of the screen 2. The area selection module 3 instructs the CPU 10 to highlight a rectangular area 73 defined by the first variable and the second variable, by i.e. a fluorescent color (step S8). Therefore the user can check a preview of the area to be selected with view of the real world in overlapped manner on the screen.

After the user selecting the starting point of the OCR by pressing the function key 3, the string in lower center 44 of the screen changes to “Select (2)”. It shows that if the function key 3 is released then the ending point of the OCR area will be selected.

In step S9, the area selection module 33 observe for the releasing of the function key 3 in cooperation with the CPU 10. To select the ending point of the OCR area, the user moves the imaging phone 1 by hand so that the lower right corner of area 42 is displayed on the center of the screen 2. Then as shown in FIG. 6(d), the second pointer 72 points at the lower right corner of area 42. The first pointer 71 is not displayed because the position corresponding to the value of the first variable is out of the screen 2.

When detecting the function key being released, the area selection module 33 enters to a state to observe the movement of the imaging phone 1 by using movement detection module 36 (step S11). If detecting the motion of imaging phone 1, the area selection module 33 changes values of both the first variable and the second variable so as to compensate the motion of the imaging phone 1. In addition, the area selection module 33 instructs the CPU 10 to re-display the first pointer 71, the second pointer 72 and the rectangular area 73 at the position on the screen 2 corresponding to the new values of the first variable and the second variable respectively. As a result, the view of the real world shown in the rectangular area 73 does not change even the imaging phone 1 is moved. The user can see the selected region of the real world in the screen 2.

After the user selecting the ending point of the OCR by releasing the function key 3, the string in lower center 44 of the screen changes to “Go”. It shows that next time if the function key 3 is pressed then the rectangular area 73 will be decided as a area for OCR. That is, the camera module 7 will capture a view of the inside of the rectangular area 73, and the OCR will be applied for the taken image data. Thus, to obtain the desired character string, it is necessary to adjust the spatial position of the imaging phone 1 so as to display a whole of the rectangular area 73 in the screen 2, as shown in FIG. 6 (f).

Referring to FIG. 6(e), the user moves the imaging phone 1 to the direction 49 to make all the selected areas 73 displayed on the screen 2. Then the area selection module 33 move the first pointer 71, the second pointer 72 and the rectangular area 73 to the direction 50 so as to compensate the motion of the imaging phone 1 (step S12). The rectangular area 73 is highlighted by i.e. a fluorescent color (step S13). The user moves the imaging phone 1 until the screen comes to the status of FIG. 6 (f).

The area selection module 33 observes pressing of the function key 3 again (step S14). When function key 3 is pressed, the area selection module 33 decides area 73 as the operation area for performing the OCR operation (step S15). In this way, the user can select the OCR area as if he/she puts the marks on the real world with watching a view of the real world in the screen 2, by a simple key operation and intuitive hand movement. Thus a very intuitive and effective user interface is realized.

Then in step S16, by using the camera control module 34, the OCR software 19 instructs the CPU 10 or the control program of the camera module 7 to capture the view of the operation area to build an image data of the area. There may be 2 implementations to obtain an image data contains only information of the operation area. One is that the CCD driver 25 controls the CCD sensor 24, by the control of the CPU 10, to acquire data only from the pixels corresponding to the operation area. Another one is to acquire data from all pixels of the CCD sensor 24, and to extract necessary data from the obtained image data by means of CPU 10.

Then in step S17, the OCR software 19 instructs CPU 10 to obtain acceleration information from the accelerometer 13a. Obtained acceleration information represents the inclination of imaging phone 1, and is used to correct the image data obtained in step S16. The accuracy of OCR may be expected to be improved by correcting the inclination. The inclination correction function with using acceleration sensor 13a can be turned off by the user's selection.

In step S18, the OCR module 35 of the OCR software 19 applies OCR to the image data obtained by camera control module 34 and extracts character information with the cooperation of CPU 10. The algorithms of OCR have already been known, and any algorithm may be used if it matches with the requirements of i.e. processing speed, power consumption, or language. By the OCR processing, the character information of “These text are to be extracted” can be extracted, which exists in the view of the area indicated by numeric 73 in FIG. 6 (f). In addition, OCR module 35 instructs CPU10 to store the character information obtained by OCR in the shared memory space which is used to transfer data between applications or within an application (step S13). Therefore, character information obtained by the OCR software 19 may be used from various applications installed in the imaging phone 1, such as text editors, word processors, electronic memos, messaging applications, or internet browsers. The shared memory space is prepared in DRAM17. In step 14 the OCR software 19 stop working.

Further, in the step S6 or step S11, if the movement detection module 36 detects that the amount of movement of the imaging phone 1 is larger than the certain threshold, it shows an error message on the screen 2 (step S21) and initialize the OCR software 19 by the function key 3 being pressed (step S22). This is because such a large movement will make it difficult to ensure the accuracy of the motion detection module 36.

In this way, the imaging phone 1 according to the present invention enables a user to overlap and see the selected area for OCR operation on the real world view in the screen 2, which enables a user to understand intuitively the relationships between the operation area and the real world.

Furthermore, in imaging phone 1 according to this invention, all operations of setting the operation area for the OCR, taking image data, and executing OCR can be completed by a simple key manipulation of pressing and releasing the function key 3. Therefore, the user may be able to interact with character information on the real world intuitively and efficiently. And the user may be able to take character information on the real world into imaging phone 1 intuitively and efficiently. Such character information could not only be just a text but also be a e-mail address, URL, telephone number and etc. The taken character information could be pasted on applications such as electronic memos or MMS. In this way, the imaging phone 1 can acquire information on the real world in a way like a copy & paste operation in the personal computers.

In the other embodiment, the area selection module 33 may be arranged as follows.

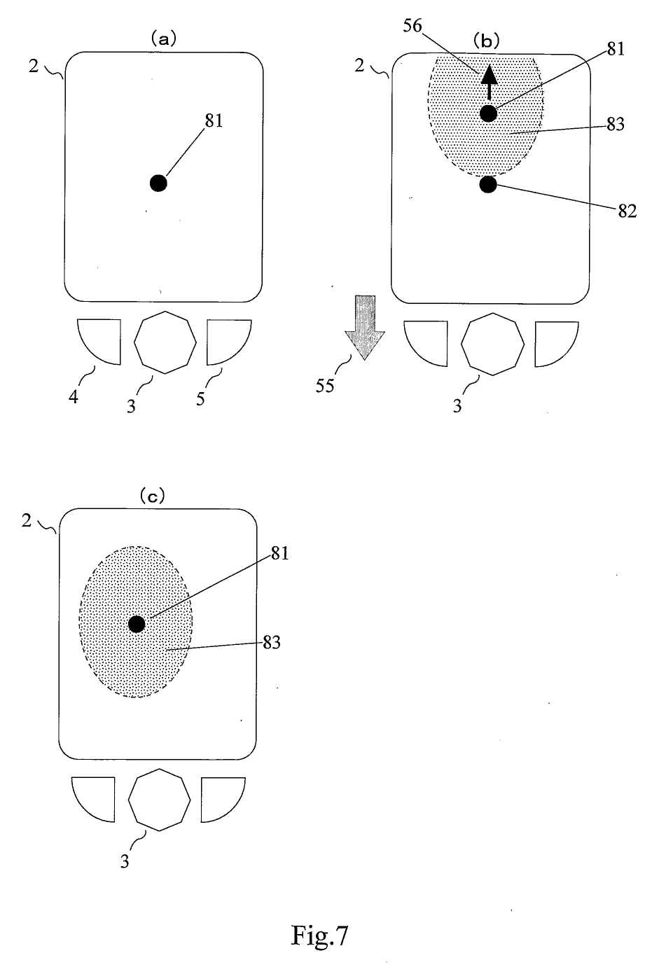

When the area selection module 33 starts to run, it prepares one variable. As shown FIG. 7 (a), the area selection module 33 display a pointer 81 at the center of the screen 2 corresponding to the initial value of the variable. The user moves the imaging phone 1 so that the center of the region of the real world where the user wish to select is displayed at the center of the screen 2, and then press the function key 3.

If the function key 3 is pressed, the area selection module 33 changes the value of said variable with the help of the motion detection module 36 so as to compensate the movement of the imaging phone 1. In addition, the area selection module 33 instructs the CPU 10 to re-display the pointer 81 at the position on the screen 2 corresponding to the new value of said variable. Therefore, even the imaging phone 1 moves the place where the pointer 81 is pointing does not change. Referring to FIG. 7 (b), if the user moves the imaging phone 1 to the lower direction 55, the pointer 81 moves to the upper direction 56.

The area selection module 33 keeps displaying a bright point 82 at the initial position of pointer 81. And the area selection module 33 instructs CPU 10 to display an oval 83 having a radius corresponding to a distance of the pointer 81 and the bright point 82, and a center corresponding to a position of the pointer 81. The oval 83 is highlighted by a fluorescent color. If the pointer 81 is moved, then the position of the oval 83 is also updated. Therefore, the place of the real world surrounded by the oval 83 does not change even if the imaging phone 1 moves.

When the user release the function key 3, the area selection module 33 fixes the radius oval 83. The area selection module 33 continues to move the pointer 81 on the display 2 so as to compensate the movement of the imaging phone 1, and the oval 83 is also moved on the screen 2 along with it. The user moves the imaging phone 1 so that oval 83 may come to a suitable position on screen 2 (see FIG. 7 (c)).

The imaging phone 1 uses the area surrounded by the oval 83 as an area for adjusting focus and white balance. When the oval 83 moves, the CPU 10 re-adjust the focus or white balance by controlling the lens motor 23 and the pre-processing unit 26. Therefore the user can set the focus or the white balance to any place in the screen 2. The user can take a picture of the scene displayed on the screen 2 by pressing the function key 3 again.

In this way, the user can select the focusing area as if he/she puts the marks on the real world with watching a view of the real world in the screen 2, by a simple key operation and intuitive hand movement. Thus a very intuitive and effective user interface is realized.

The present invention has been described above by using exemplary embodiments. But it should be noted that the embodiments of the present invention can take a lot of variations, the various modification may be possible within the scope of the present invention. For example, the area selection module 33 or the motion detection module 36 may be used from the other software. And the area on the LCD screen 2 specified by the area selection module 33 may be used for purposes which do not need to take a photography. For example, the OS 21 or the software for controlling the camera module 7 may use the specified area for adjusting the focus or the white balance. It may be possible to zoom electronically inside of the selected area. It may be possible to add colors or frames for the selected area of the photograph. In addition, the imaging phone 1 may comprise not only the accelerometer but also a gyroscopes and a magnetometer to arrange their output to use to correct the image data. The electronic device according to the present invention may comprise two or more functions that use the area selection module 33. In such embodiment the electronic device may comprise a user interface for switching the function. For example, the electronic device by the present invention may be arranged to switch an operation of performing OCR for the image data of the operation area and an operation of preparing the image data to be transmitted by a messaging application such as MMS or E-mail.

1. An electronic device comprising:
an image sensor;
a screen for displaying a view captured by the image sensor;
a motion detection means for detecting a motion of the electronic device;
a variable being associated with a position on the screen and a predetermined selecting manipulation; and,
an OCR means
and the electronic device being arranged:
to change a value of the variable in every moment triggered by the selecting manipulation so as to compensate a motion of the electronic device by utilizing the motion detection means; and
to define an operation area associated with an operation of the electronic device based on the value of the variable;
where said operation comprising taking an image date by capturing a view of the operation area by the image sensor, extracting a character information from the image data as a text data by the OCR means, and storing the text data in a shared memory space which is used to transfer data between applications or within an application.

2. An electronic device according to claim 1, comprising a plurality of variables, each of them being associated with a own position on the screen and a own selecting manipulation, and wherein the electronic device being arranged to define said operation area based on values of said plurality of variables.

3. An electronic device according to claim 1 being arranged to indicate on the screen a position relating to the value of the variable.

4. An electronic device according claim 1, wherein an initial value of the variable relating to a center position of the screen.

5. An electronic device according to claim 1 being arranged to define a screen area based on the value of the variable, and to indicate the screen area on the screen.

6-14. (canceled)

15. An electronic device according to claim 1, wherein said motion detection means comprising an accelerometer for measuring inclination of the electronic device, where the inclination is used for correcting the image data to improve an accuracy of OCR processing.

16. A mobile phone comprising
a camera for taking a picture;
a user interface having at least one key;
a screen for displaying a view captured by the camera;
motion detection means for detecting a motion of the mobile phone; and
a processor having an OCR function;
where the processor further comprising a first and a second variables associated with a position on the screen; and the processor being arranged:
in response to press the key, to start changing the values of the first variable so as to compensate a motion of the mobile phone which is detected by the motion detection means and indicating a rectangle area on the screen which is determined by positions corresponding to the current values of the first and the second variables as opposite corners;
in response to release the key which corresponds to the pressing of the key, to start changing the values of the second variable so as to compensate a motion of the mobile phone which is detected by the motion detection means and to continue indicating the rectangle area on the screen which is determined by positions corresponding to the current values of the first and the second variables as opposite corners;
in response a further operation of the user interface, to take an image date by capturing a view of the operation area by the camera, to extract a character information from the image data as a text data by an OCR processing and to store the text data in a memory space so that the text data can be pasted in an application program of the mobile phone.

17. A computer program for an electronic device comprising an image sensor, a screen for displaying a view captured by the image sensor, a motion detection means for detecting a motion of the electronic device, and a processor;
the computer program comprising a variable associated with a position on the screen and a predetermined selecting manipulation;
and the computer program being arranged to instruct the processor to perform:
changing a value of the variable in every moment triggered by the selecting manipulation so as to compensate a motion of the electronic device by utilizing the motion detection means; and
upon finishing the selecting manipulation, defining an operation area based on the value of the variable, taking an image date by capturing a view of the operation area by the image sensor, extracting a character information from the image data as a text data by an OCR processing, and storing the text data in a shared memory space which is used to transfer data between applications or within an application.

18. A computer program according to claim 17, comprising a plurality of variables, each of them being associated with a own position on the screen and a own selecting manipulation, and being arranged to instruct the processor to define said operation area based on values of said plurality of variables.

19. A computer program according to claim 17, comprising:
a means for instructing the processor to indicate on the screen a position relating to the value of the variable; and
a means for instructing the processor to define a screen area based on the value of the variable, and to indicate on the screen the screen area.

20. A computer program according to claim 17 being arranged to instruct the processor to show an error message on the screen when the motion detection means detecting a motion being larger than a threshold.

21. A method for copying undigitized character information as a digitized text data for an electronic device comprising an image sensor, a screen for displaying a view captured by the image sensor, a motion detection means for detecting a motion of the electronic device and a variable being associated with a position on the screen and a predetermined selecting manipulation; where the method comprising the steps of:
changing a value of the variable in every moment triggered by the selecting manipulation so as to compensate a motion of the electronic device by utilizing the motion detection means;
defining an operation area based on the value of the variable; and,
taking an image date by capturing a view of the operation area by the image sensor, extracting a character information from the image data as a text data by an OCR processing, and storing the text data in a shared memory space which is used to transfer data between applications or within an application.
